(19) United States
(12) Patent Application Publication
(10) Pub. No.: US 2005/0122062 A1
(43) Pub. Date: Jun. 9, 2005

(54) Light emitting diode driving circuit

(76) Inventor: Yung-Hsiang Hsu, Sinjhuang City (TW)

Correspondence Address: TROXELL LAW OFFICE PLLC, 5205 LEESBURG PIKE, SUITE 1404, FALLS CHURCH, VA, 22041, US

(21) Appl. No.: 10/729,929

(22) Filed: Dec. 9, 2003

(51) Int. Cl. H05B 39/04

(52) U.S. Cl. 315/291; 315/224

(57) ABSTRACT

A light emitting diode (LED) driving circuit includes a power supply, a rectification circuit, an LED array and a current control circuit. The invention is characterized that, when the power supply passes through the current control circuit, using charging and discharging of a capacitor and parallel equivalent resistance current-limiting characteristics of a capacitor and a resistor, the rectification circuit converts an alternating current into a direct current that is outputted to the LED array, thereby providing the LED array with a stable quota driving current.

### BACKGROUND OF THE INVENTION

(a) Field of the Invention

The invention relates to a light emitting diode (LED) driving circuit, and more particularly, to an LED driving circuit characterized that, when a power supply passes through a current control circuit, using charging and discharging of a capacitor and parallel equivalent resistance current-limiting characteristics of a capacitor and a resistor, a rectification circuit converts an alternating current into a direct current that is outputted to an LED array, thereby providing the LED array with a stable quota driving current.

(b) Description of the Prior Art

With reference to FIG. 1 showing a prior light emitting diode (LED) driving circuit, wherein an alternating current first is inputted from a power supply A. After stepping-down or stepping-up using an adaptor B, the alternating current is passed through a rectification circuit D, a wave-filter circuit D and a regulator circuit E, and converted into a direct current further inputted into an LED array G, thereby conducting and illuminating the LED array G.

However, a common adaptor B is not only bulky in volume but also heavy in weight, and is consisted of coils. Therefore, the adaptor B easily incurs magnetic fields that interfere with normal operations of other circuits. In addition, an LED driving circuit has fixed output voltages usually being 5-volt or 12-volt. When using the adaptor B, a large amount of circuits is used for outputting the direct current F, and production costs are thus likely increased to unnecessarily add loadings upon manufacturers.

Therefore, it is a vital task of the invention as how to overcome the aforesaid technical drawbacks.

### SUMMARY OF THE INVENTION

Referring to FIG. 2, a light emitting diode (LED) driving circuit according to the invention comprises a power supply A, a rectification circuit C, an LED array G and a current control circuit H.

The structure according to the invention is characterized that, when the power supply A passes through the current control circuit H, using charging and discharging of a capacitor and parallel equivalent resistance current-limiting characteristics of a capacitor and a resistor, the rectification circuit C converts an alternating current into a direct current F that is outputted to the LED array G, thereby providing the LED array G with a stable quota driving current.

Referring to FIG. 3, a resistor 12 has two effects. One of the effects is for micro tuning resistance in conjunction with a resistor I1 and a capacitor J1, and hence a value of the resistor 12 is relatively small. When a power supply receptacle is at a bouncing state, if a voltage of a transient state and an input voltage are opposite, an instantaneous current passing through capacitors J1 and J2 may surge to a very large value. At this point, the other effect of the resistor 12 is for serving as a current-limiting buffer for the instantaneous current, so as to prevent the capacitors J1 and J2 from damaging.

The LED array G operates in a series connection and is capable of controlling illumination difference within a specific range, and uneven luminance is not resulted from different forward bias and differences in resistance matching regarding to manufacturing process thereof.

Discussions on alternating current and direct current shall be given below.

1. Alternating Current (Mains Fequency 50/60 Hz)

The resistor I1 and the capacitor J1 are for impedance matching in order to control an operating current of an LED L and inputted via the LED array G. Because of transient effects of capacitance caused by incision angle of the mains frequency, the capacitor J1 serves as a discharging loop via the resistor I1, and the capacitor J2 serves as a discharging loop (utilized for illuminating the LED array G) via the LED array G. Hence, influences that the transient effects have on the circuit are eliminated.

The mains frequency of 60 Hz becomes half-waves of 120 Hz after passing through a bridge full-wave rectifier. Without taking effects of the capacitor J2 into consideration beforehand, conductance angle positive half-cycle is θ≦positive half-cycle conductance angle≦(180°−θ). Conductance ratio of each cycle is (180°−20)/180°, and conductance cycle is 1/120 seconds per cycle (a symmetrical half-wave of 90° is used to consider a square root of an average voltage 110V, where θ=sin −1 (total forward bias/110) and 0°≦θ≦90°), and a total value of forward bias is equal to a sum of forward bias of the diodes K1 and K4, and the LED array G. At this point, by adding capacitance charging-discharging effects of the capacitor J2, the conductance θ is increased. Thus, conductance ratio of each cycle is enlarged for improving glittering of the LED array G. When the operation is performed in reverse for negative half-cycles, the outcomes are also the same.

2. Direct Current (Linear Power Supplier or Switch-type Power Supplier)

Using principle of superposition, a power composition region is divided into direct current and high-frequency harmonic waves, which shall be individually discussed. The direct-current resistance I1 serves for impedance matching to control an input current entering the LED array G to maintain approximately to an LED quota current. The capacitors J1 and J2 are regarded as open circuits and are not taken into consideration. When positively connected, a current loop passes through the diodes K1 and K4. When negatively connected, the current loop passes through the diodes K2 and K3. Thus, the direct-current power is conducted at all times.

As for the high-frequency harmonic waves, because impedances of the capacitors J1 and J2 are frequency functions, an impedance of the resistor I1 is much higher than that of the capacitor J1 at high frequencies. In parallel circuits when the impedance difference is above ten times, lowest impedance is used for calculation and highest impedance is neglected. When the power supply is at a positive loop, the loop passes through the capacitor J1, the diode K1, the capacitor J2 and the diode K4. When the power supply is at a negative loop, the loop passes through the capacitor J1, the diode K2, the capacitor J2 and the diode K3. In addition, forward bias of the diodes K1, K2, K3 and K4 is extremely small and can be disregarded. Then, a loop load ratio of the capacitor J1 and the capacitor J2 is dependent on capacitance of the capacitor J1 and the capacitor J2. From the above, a continuous current i according to the voltage at the capacitor is C (dVc/dt). When charging the capacitor and the i is positively discharged, i is negative. The capacitor J1 becomes a discharging loop via the resistor I1, and the capacitor J2 becomes a discharging loop via the LED array G. The capacitor J1 is capable of absorbing partial energy of the high-frequency harmonic wave component, so as to avoid energy of the high-frequency harmonic wave component being entirely born by the capacitor J2.

By adding the two aforesaid effects, the result is an equivalent outcome of the direct current power supply.

Wherein, the power A comes from the circuit without using alternating elements such as an adaptor, so that the power supply directly inputs an alternating current or a direct current for increasing usage conveniences.

### BRIEF DESCRIPTION OF THE DRAWINGS

FIG. 1 shows a block diagram of a prior LED driving circuit.

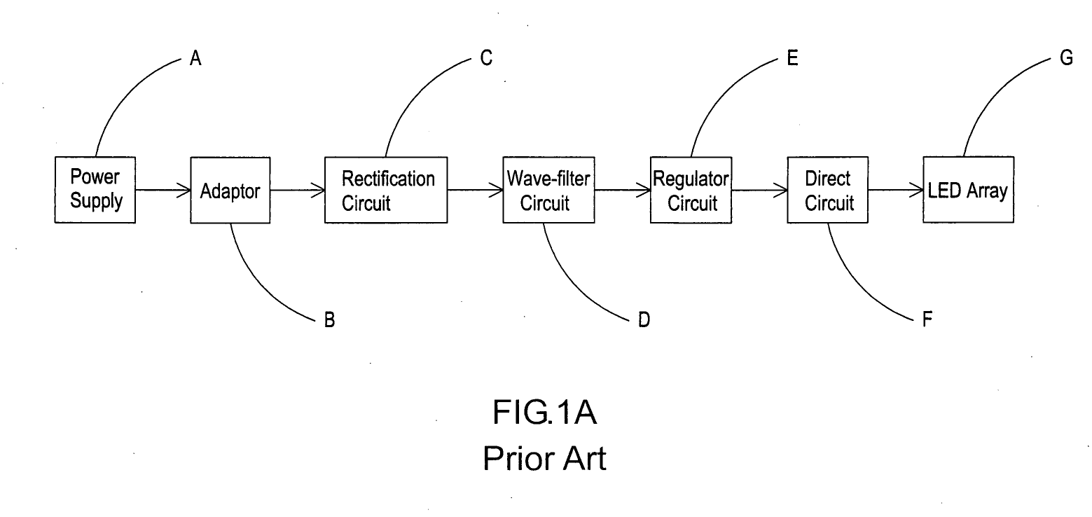

FIG. 2 shows a circuit block diagram according to the invention.

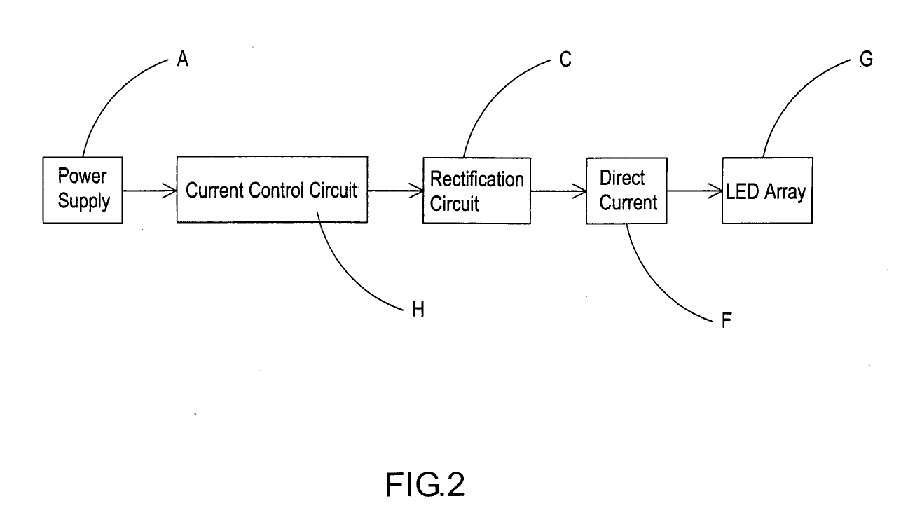

FIG. 3 shows a circuit in an embodiment according to the invention.

### DETAILED DESCRIPTION OF THE PREFERRED EMBODIMENTS

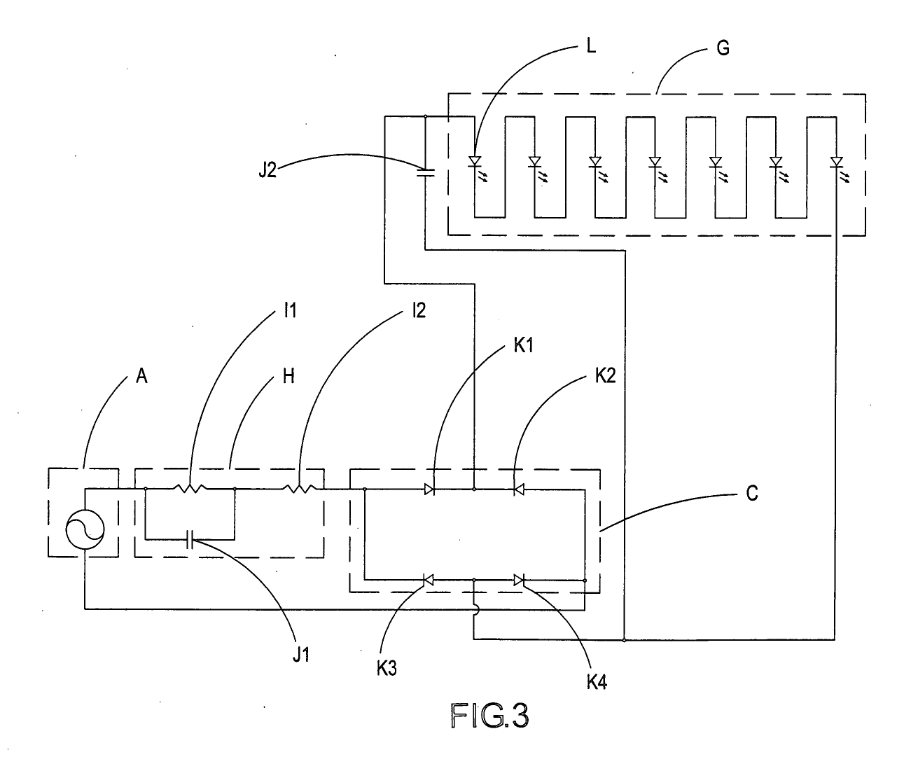

Referring to FIG. 3 showing an LED driving circuit in an embodiment according to the invention, during a positive half-cycle, the current outputted from the power supply A first passes through the resistor I1 and the capacitor J1 of the current control circuit H, and then passes through the resistor I2. Using micro tuning of the serially connected resistor I2, the current is reduced. In the rectification circuit C, for that the diode K1 is conducted in a forward direction and the diode K3 is not conducted in a reverse direction, the current is directly inputted into the LED array G and returned to the power supply A after passing though the diode K4, thereby conducting the illuminating diodes L at the LED array G for illumination. Furthermore, the capacitor J2 is connected before the LED array G, and hence it is favored that pulses and surges produced be absorbed when the power supply is instable.

During a negative half-cycle, for that the diode K2 is conducted in a forward direction and the diode K4 is not conducted in a reverse direction, the current is directly inputted into the LED array G and returned to the power supply A after passing though the diode K3, thereby conducting the illuminating diodes L at the LED array G for illumination. Furthermore, the capacitor J2 is connected before the LED array G, and hence it is favored that pulses and surges produced be absorbed when the power supply A is instable.

To make the novelty and practicability of the invention more distinguishing, the present invention is compared with the prior invention.

Shortcomings of the prior invention:
1. An adaptor is necessarily used to likely incur electromagnetic interference.
2. It is essential to use an alternating current as a power input instead of using a direct current as well.
3. A large amount of electronic components is used with high production costs produced.

Excellence of the present invention:
1. Minimal circuit elements are used to offer lower production costs and easy manufacturing processes.
2. Alternating elements such as an adaptor is eliminated, and a direct current can be directly inputted.
3. No electromagnetic interference is caused.
4. The invention provides novelty and practicability.
5. The invention offers industrial competitiveness.

It is of course to be understood that the embodiment described herein is merely illustrative of the principles of the invention and that a wide variety of modifications thereto may be effected by persons skilled in the art without departing from the spirit and scope of the invention as set forth in the following claims.

1-2. (canceled)

3. A light emitting diode driving circuit comprising:
a) a power supply providing a current;
b) a current control circuit connected to the power supply and having:
i) a first resistor;
ii) a first capacitor connected in parallel with the first resistor; and
iii) a second resistor connected in series with the first resistor and the first capacitor;
c) a light emitting diode array having a plurality of light emitting diodes;
d) a rectification circuit connected between the current control circuit and the light emitting diode array and converting an alternating current into a direct current, the second resistor being located between the rectification circuit and the first resistor and the first capacitor; and
e) a second capacitor connected before the light emitting diode array and providing a charging-discharging effect and increasing a conductance.

4. The light emitting diode driving circuit according to claim 3, wherein the current of the power supply includes an alternating current and a direct current.
